(19) United States
(12) Patent Application Publication
(10) Pub. No.: US 2009/0079856 A1
(43) Pub. Date: Mar. 26, 2009

(54) SOLID-STATE IMAGING DEVICE AND DRIVING METHOD THEREFOR

(75) Inventor: Kouji Yahazu, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/211,477

(22) Filed: Sep. 16, 2008

(30) Foreign Application Priority Data
Sep. 20, 2007 (JP) 2007-243263

(51) Int. Cl. H04N 5/335

(52) U.S. Cl. 348/294; 348/E05.091

(57) ABSTRACT

A solid-state imaging device and a driving method thereof are disclosed. The solid-state imaging device includes a pixel array, vertical signal lines, a constant current source, a signal processing circuit. The pixel array includes a plurality of pixels arranged in a matrix. The vertical signal lines are disposed for each pixel column in the pixel array and connected to a transistor at an output stage of the pixels in a source-follower configuration. The constant current source supplies a constant current to the vertical signal lines. The signal processing circuit reads out electrical signals from the pixels. One side of the vertical signal lines are connected to the constant current sources, and the other side of the vertical signal lines are connected to the signal processing circuit.

### CROSS-REFERENCE TO RELATED APPLICATIONS

The present application claims benefit of priority of Japanese patent Application No. 2007-243263 filed in the Japanese Patent Office on Sep. 20, 2007, the entire disclosure of which is incorporated herein by reference.

### BACKGROUND OF THE INVENTION

1. Field of the Invention

The present invention relates to a solid-state imaging device and a driving method therefor. More particularly, the invention is directed to a solid-state imaging device which reads out electrical signals from pixels by utilizing a constant current source, and to a driving method therefor.

2. Description of Related Art

A known complementary metal-oxide semiconductor (CMOS) image sensor (see, e.g., Japanese Unexamined Patent Application Publication No. H 10-126697) includes, as shown in FIG. 5, a pixel array 102 including a plurality of pixels 101, a vertical scanning circuit 103, a column signal processing unit 104, a horizontal scanning circuit 106, a data signal processing unit 107, and a timing generator 108. The plurality of pixels 101 are arranged in a matrix, each pixel including a photoelectric conversion element. The vertical scanning circuit 103 selects the respective pixels of the pixel array by one row at a time to control a shutter operation and a readout operation for the pixels. The column signal processing unit 104 reads out signals from the pixel array by one row at a time, and performs a signal processing (e.g., CDS processing (processing of removing fixed pattern noise attributable to threshold variations in pixel transistors), auto-gain control (AGC) processing, analog-to-digital conversion processing, and the like). The horizontal scanning circuit 106 inputs signals from the column signal processing unit into a horizontal signal line 105 by selecting one signal at a time. The data signal processing unit 107 performs data conversion on the signal from the horizontal signal line into an intended output mode. The timing generator 108 supplies various pulse signals necessary for operating various portions on the basis of a reference clock.

Here, as shown in FIG. 6, each of the pixels of the pixel array includes a photodiode (PD) 110, a transfer transistor (transfer Tr) 112, an amplification transistor (amplification Tr) 113, a selection transistor (selection Tr) 114, and a reset transistor (reset Tr) 115. The PD stores electrons generated by photoelectric conversion. The transfer Tr 112 transfers the electrons stored in the PD to a floating diffusion (FD) 111. The amplification Tr 113 converts a potential change in the FD into an electrical signal, with a gate thereof connected to the FD. The selection Tr 114 selects the pixel for reading out a signal for each column. The reset Tr 115 resets the potential of the FD to a power supply potential (Vdd). Furthermore, the selection Tr is operatively connected to a vertical signal line 116 interconnected to each column of pixels, in a source-follower configuration. The vertical signal line is connected to a constant current source 117 for supplying a constant current to the vertical signal line, and also connected to the column signal processing unit.

In the known solid-state imaging device, the constant current source and the column signal processing unit are connected to one side (in the same direction) of the vertical signal line, and thus it is configured such that the constant current flows toward the column signal processing unit from the pixel.

In the known solid-state imaging device constructed as described above, a voltage linking with the voltage of the FD is outputted to the vertical signal line by making the selection Tr of the pixel ON-state, so that the voltage outputted to the vertical signal line is transferred to the column signal processing unit through a load of the constant current source.

### SUMMARY OF THE INVENTION

However, even for pixels to be read out via the same vertical signal line, the distance to the column signal processing unit differs depending on their arranged position. As a result, interconnect resistances across the vertical signal line differ from one pixel to another.

Namely, it is assumed that n pixels are connected to the vertical signal line, and that a interconnect resistance between a vertical signal line position to which a pixel along an i-th line is connected and a vertical signal line position to which pixels of an (i+1)-th line is connected is Ri. Then, a voltage of a first-line pixel is transferred to the column signal processing unit via a resistance of [R1+R2+ . . . +R(n−1)], a voltage of a second-line pixel is transferred to the column signal processing unit via a resistance of [R2+R3+ . . . +R(n−1)], and a voltage of an n-th line pixel is transferred to the column signal processing unit via a resistance of R(n−1), and thus the interconnect resistances across the vertical signal line differ for each pixel (for each line in which the pixel is arranged).

The fact that the interconnect resistances across the vertical signal line differ for each pixel means that voltage drops differ for each pixel.

Namely, supposing that the constant current source causes a current I to flow through the vertical signal line, the first-line pixel has a voltage drop of [R1+R2+ . . . +R(n−1)]×I, the second-line pixel has a voltage drop of [R2+ . . . R(n−1)]×I, and the n-th-line pixel has a voltage drop of R(n−1)×I, and thus voltage drops differ for each pixel (for each line along which the pixel is arranged) (see FIG. 7). In addition, if the voltage drops differ for each pixel (for each line along which the pixel is arranged), a shading occurs in a longitudinal direction of image.

Referring to a timing chart, the above-described voltage drops will be described below.

Here, FIG. 8 is a timing chart of various pulses, with a schematic diagram for illustrating input voltage to the column signal processing unit, where Φ_{T} is a pulse controlling the transfer Tr, Φ_{R} is a pulse controlling the reset Tr, Φ_{S} is a pulse controlling the selection Tr, and V is the input voltage to the column signal processing unit.

To transfer an electrical signal of a pixel to the column signal processing unit, Φ_{S1} which is a selection pulse for a first line is set to a high (H) level and then Φ_{R1} which is a reset pulse for a first-line pixel is set to the H level at a timing labeled t1 in the drawing. As a result, a reset level of the pixel is outputted to the input voltage V to the column signal processing unit. Then, after setting Φ_{R1} to a low (L) level, Φ_{T1} is set to the H level at a timing labeled t2 in the drawing to turn the selection Tr on, so that the first-line pixel is operatively connected to the vertical signal line. As a result, charges stored in the first-line pixel are reflected in the input voltage V to the column signal processing unit. Thereafter, by setting Φ_{T1} to the L level at a timing labeled t3 in the drawing, the selection Tr is turned off, thereby breaking the connection between the first-line pixel and the vertical signal line.

The readout of the charges stored in the pixel is performed on the basis of a difference between an input voltage value (see “P_phase” in the drawing) to the column signal processing unit when the reset pulse is inputted and an input voltage value (see “D_phase” in the drawing) to the column signal processing unit when the charges of the pixel are transferred.

Then, after setting Φ_{S2} which is a selection pulse for a second line to the H level, Φ_{R2} which is a reset pulse for a second-line pixel is set to the H level at a timing labeled t4 in the drawing. As a result, a reset level of the pixel is outputted to the input voltage V to the column signal processing unit. Then, after setting Φ_{R2} to the L level, T2 is set to the H level at a timing labeled t5 in the drawing to turn the selection Tr on, so that the second-line pixel is operatively connected to the vertical signal line. As a result, charges stored in the second-line pixel are reflected in the input voltage V to the column signal processing unit. Thereafter, by setting Φ_{T2} to the L level at a timing labeled t6 in the drawing, the selection Tr is turned off, thereby breaking the connection between the second-line pixel and the vertical signal line.

The readout of charges stored in pixels is performed similarly for pixels in a third and subsequent lines. As shown in FIG. 8, the input voltages to the column signal processing unit during application of the reset pulses differ for each line due to the influence of a voltage drop.

By the way, for solid-state imaging devices implemented in digital cameras and the like, an increase in the number of pixels and a pitch reduction have been pursued at a rapid pace in order to enhance their resolution. Accordingly, a resultant decreased pixel aperture area causes lower sensitivity, which becomes a serous issue. Among solid-state imaging devices, it is required that CMOS image sensors, in particular, which achieve signal transfer by laying out metal-wiring within each pixel, ensure the aperture area by narrowing the width of the metal-wiring in order to enhance their resolution. When the width of the metal-wiring is narrowed, interconnect resistance increases, thereby aggravating the above-described shading.

Accordingly, it is desirable to provide a solid-state imaging device capable of suppressing shading and achieving enhancement of image quality, and a driving method therefor.

In accordance with one embodiment of the present invention, there is provided a solid-state imaging device including a pixel array including a plurality of pixels arranged in a matrix, vertical signal lines, a constant current source, and a signal processing circuit. Each of the plurality of pixels includes a photoelectric conversion element. The vertical signal lines are disposed for each pixel column in the pixel array and connected to a transistor at an output stage of the pixels in a source-follower configuration. The constant current source supplies a constant current to the vertical signal lines. The signal processing circuit reads out an electrical signal from the pixels. One side of the vertical signal lines are connected to the constant current source, and the other side of the vertical signal lines are connected to the signal processing circuit.

According to one embodiment of the present invention, by connecting a vertical signal line to the constant current source on one side thereof and connecting the vertical signal line to the signal processing circuit on the other side thereof, the constant current source flows a current in direction opposite to that of the signal processing circuit. As a result, the influence of a voltage drop on the electrical signal of a pixel in which the signal processing circuit reads out can be reduced.

In accordance with another embodiment of the present invention, there is provided a driving method for a solid-state imaging device which includes a pixel array including a plurality of pixels arranged in a matrix, each having a photoelectric conversion element, vertical signal lines disposed for each pixel column in the pixel array and connected to a transistor at an output stage of the pixels in a source-follower configuration, a constant current source connected to the vertical signal lines and for supplying a constant current to the vertical signal lines, and a signal processing circuit connected to the vertical signal lines and for reading-out electrical signals from the pixels. The method includes a step of flowing a current in a direction opposite to the signal processing circuit by the constant current source to read out the electrical signals stored in the pixels to the signal processing circuit.

According to another embodiment of the present invention, by flowing a current in a direction opposite to that of the signal processing circuit to read out the electrical signals stored in the pixels to the signal processing circuit, the influence of voltage drops on the electrical signals of the pixels which the signal processing circuit reads out can be reduced.

In the solid-state imaging device and driving method therefore according to embodiments of the present invention, the influence of voltage drops on the electrical signals of pixels which the signal processing circuit reads out can be reduced, so that shading can be suppressed. Consequently, the enhancement of image quality can be expected.

### BRIEF DESCRIPTION OF THE DRAWINGS

FIGS. 1A and 1B are schematic diagrams for illustrating CMOS image sensors according to embodiments to which the present invention is applied;

FIG. 2 is a first schematic diagram for illustrating pixels forming a pixel array;

FIG. 3 is a schematic diagram for illustrating the readout from pixels;

FIG. 4 is a second schematic diagram for illustrating the pixels forming the pixel array;

FIG. 5 is a schematic diagram for illustrating a known CMOS image sensor;

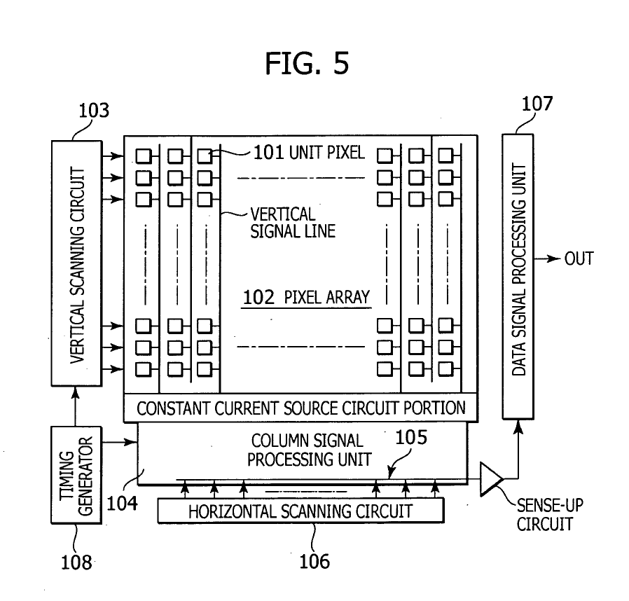

FIG. 6 is a schematic diagram for illustrating a known pixel array;

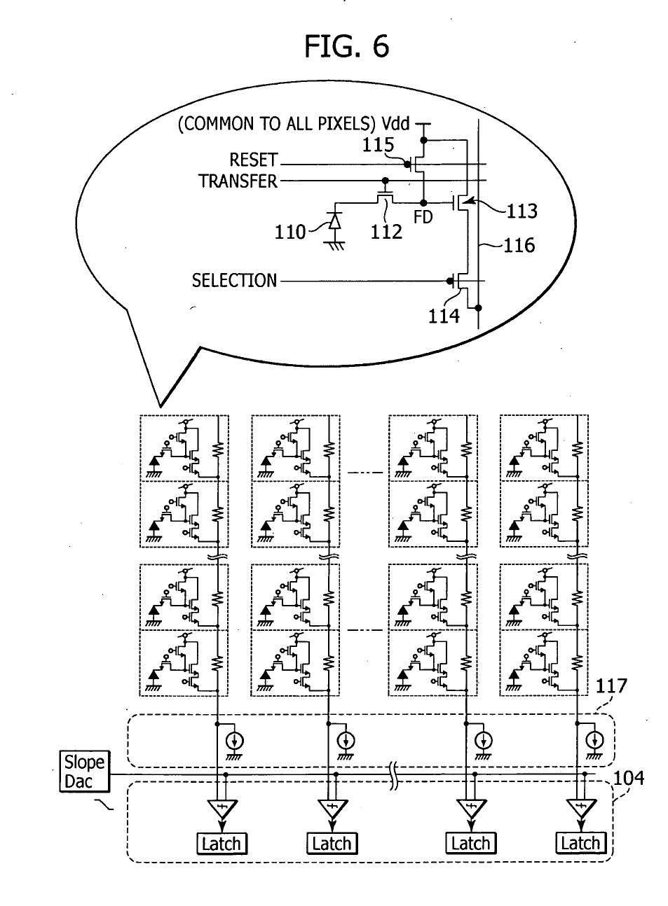

FIG. 7 is a schematic diagram for illustrating the readout from pixels in the known CMOS image sensor; and

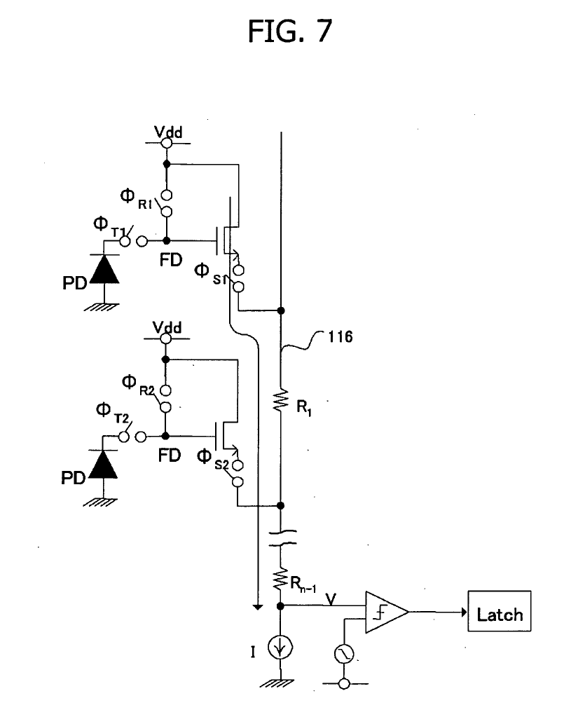

FIG. 8 is a timing chart of various pulses, with a schematic diagram for illustrating input voltage to a column signal processing unit.

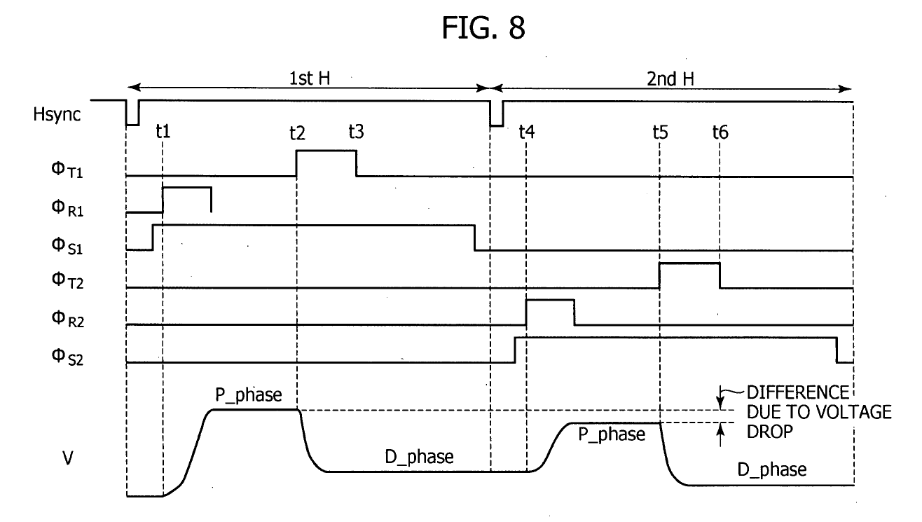

### DETAILED DESCRIPTION OF EMBODIMENTS

Embodiments of the present invention will be described below with reference to the drawings, for an understanding of the present invention.

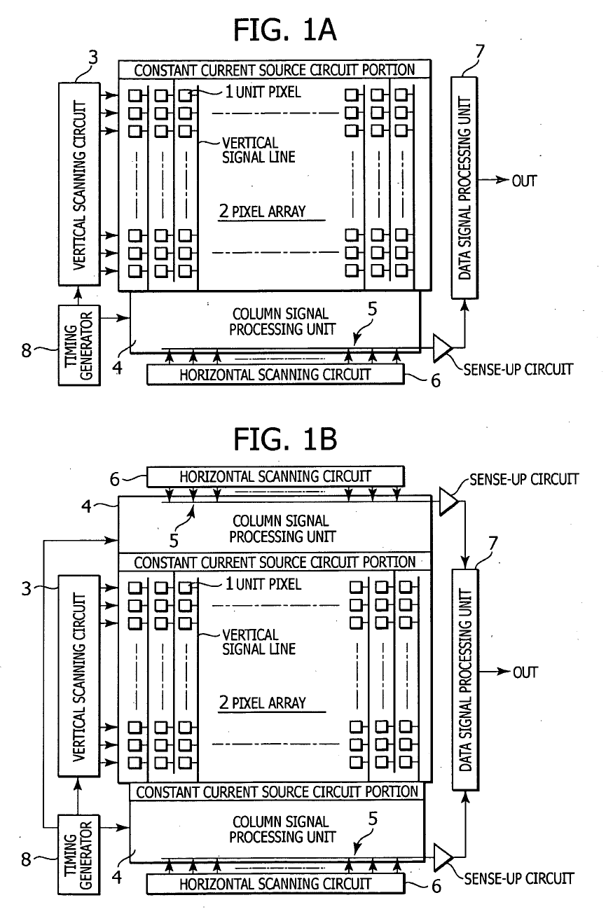

FIG. 1A is a schematic diagram for illustrating a CMOS image sensor which is one embodiment of a solid-state imaging device to which an embodiment of the present invention is applied. The CMOS image sensor herein shown has, similarly to the known CMOS image sensor, a pixel array 2 in which a plurality of pixels 1 arranged in a matrix, each pixel including a photoelectric conversion element, a vertical scanning circuit 3 for selecting the pixels of the pixel array by row at a time to control a shutter operation and a readout operation, a column signal processing unit 4 for reading out signals from the pixel array by one row at a time and performing predetermined signal processing (e.g., CDS processing, AGC processing, analog-to-digital conversion processing, and the like), a horizontal scanning circuit 6 for selecting one signal from the column signal processing unit at a time to input the selected signal to a horizontal signal line 5, a data signal processing unit 7 for performing data conversion on the signal from the horizontal signal line into an intended output mode, and a timing generator 8 for supplying various pulse signals necessary for operating various parts on the basis of a reference clock.

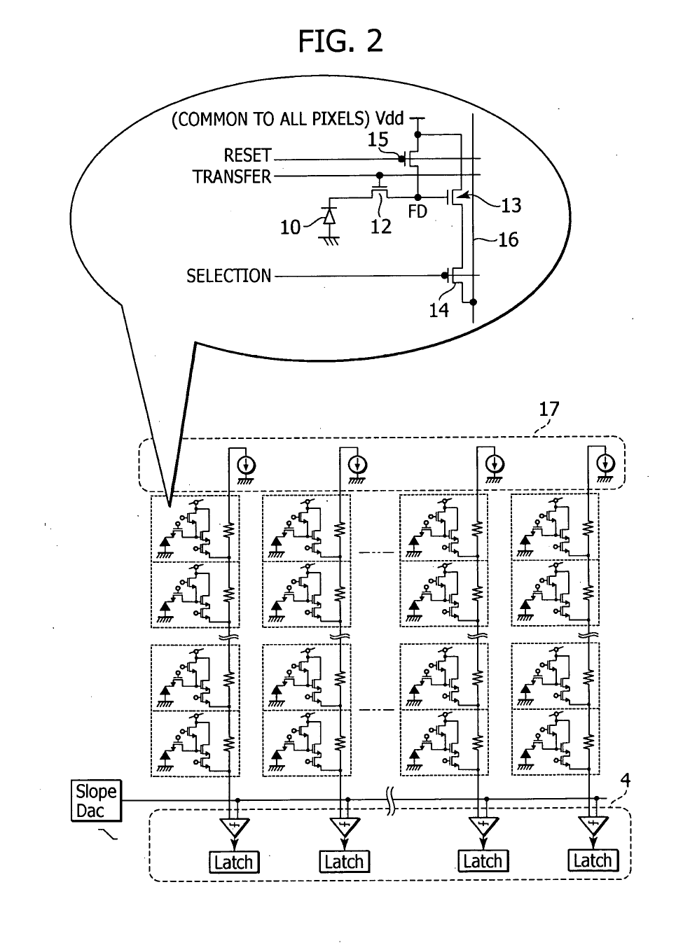

Here, each of the pixels of the pixel array includes, as shown in FIG. 2, a PD 10 for storing electrons generated by photoelectric conversion, a transfer Tr 12 for transferring the electrons stored in the PD to a FD 11, an amplification Tr 13 for converting a potential change in the FD into an electrical signal, with a gate thereof operatively connected to the FD, a selection Tr 14 for selecting the pixel, in units of rows, from which a signal is read out, and a reset Tr 15 for resetting the potential of the FD to a power supply potential (Vdd). Furthermore, the selection Tr is operatively connected to a vertical signal line 16 disposed for each column of pixels in a source-follower configuration. The vertical signal line is connected to a constant current source 17 supplying a constant current to the vertical signal line, and also connected to the column signal processing unit.

Here, in the present embodiment, the constant current source is connected to one side of the vertical signal line, whereas the column signal processing unit is connected to the other side of the vertical signal line. Namely, the constant current source and the column signal processing unit are connected to an opposite side of the vertical signal line, and thus it is configured so that the constant current flows from the pixel in a direction opposite to the column signal processing unit.

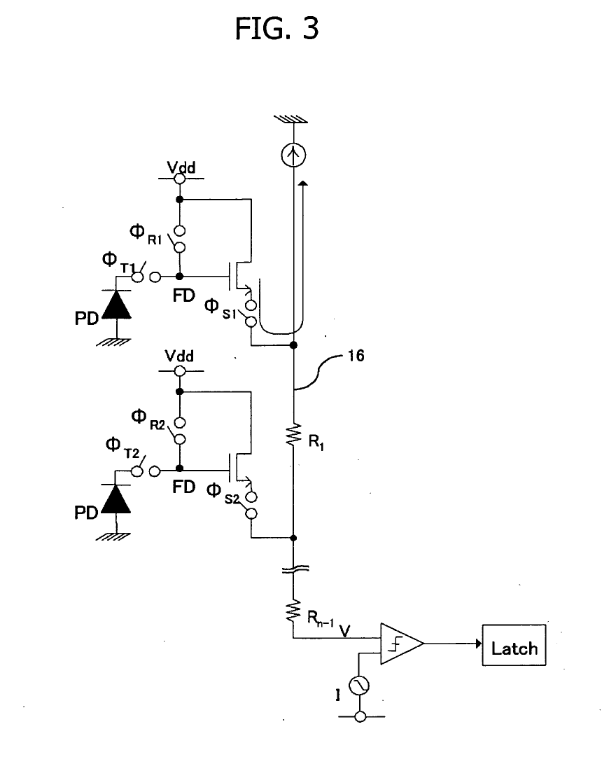

In the CMOS image sensor constructed as described above, a voltage linking with the voltage of the FD is outputted to the vertical signal line by turning the selection Tr of the pixel on, and the voltage outputted to the vertical signal line can be transferred to the column signal processing unit by a load of the constant current source. However, since the current does not flow toward the column signal processing unit, the influence of a voltage drop on the electrical signal of the pixel which the column signal processing unit reads out can be reduced (see FIG. 3). Consequently, shading can be reduced.

Furthermore, the reduction of shading is achieved only by changing the layout, and a driving system such as pulse timing can be implemented similarly to that of the known technique. Thus, the design for a CMOS image sensor is very easy.

FIG. 1B is a schematic diagram for illustrating a CMOS image sensor which is another embodiment of the solid-state imaging device to which the present invention is applied. The CMOS image sensor herein shown includes, similarly to the CMOS image sensor shown in FIG. 1A, a pixel array 2, a vertical scanning circuit 3, column signal processing units 4, a horizontal scanning circuit 6, a data signal processing unit 7, and a timing generator 8.

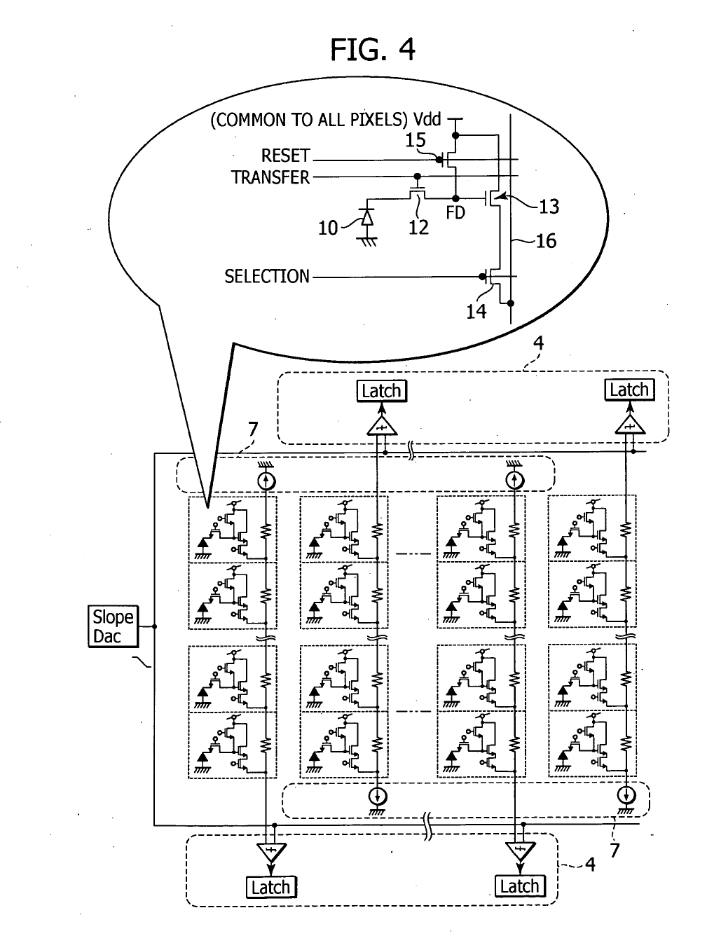

Furthermore, each of pixels of the pixel array includes, similarly to the CMOS image sensor shown in FIG. 1A, a PD 10, a transfer Tr 12, an amplification Tr 13, a selection Tr 14, and a reset Tr 15. Furthermore, the selection Tr is operatively connected to a vertical signal line 16 in a source-follower configuration. The vertical signal line is connected to a constant current source 17 for supplying a constant current to the vertical signal line, and also connected to the column signal processing units (see FIG. 4).

Here, in the present embodiment, a constant current source and a column signal processing unit are connected to an opposite side of the vertical signal lines, and a column signal processing unit connected to odd-numbered vertical signal lines is disposed on an opposite side of a column signal processing unit connected to even-numbered vertical signal lines. Specifically, [1] when the constant current source is connected to an upper side of the drawing of the odd-numbered vertical signal lines and the column signal processing unit is connected to a lower side of the drawing, the column processing unit is connected to the upper side of the drawing of the even-numbered vertical signal lines and the constant current is connected to the lower side of the drawing, whereas [2] when the column signal processing unit is connected to the upper side of the drawing of the add-numbered vertical signal lines and the constant current source is connected to the lower side of the drawing, the constant current source is connected to the upper side of the drawing of the even-numbered vertical signal lines and the column signal processing unit is connected to the lower side of the drawing.

In the CMOS image sensor constructed as described above, a voltage linking with the voltage of the FD is outputted to the vertical signal line by turning the selection Tr of the pixel ON-state, and the voltage outputted to the vertical signal line can be transferred to the column signal processing unit by a load of the constant current source. However, since the current does not flow toward the column signal processing unit, the influence of a voltage drop on the electrical signal of the pixel which the column signal processing unit reads out can be reduced (refer to FIG. 3), and thus shading can be suppressed.

Furthermore, the reduction of shading can be achieved only by changing the layout, and a driving method such as pulse timing can be achieved similarly to that of the known technique. Thus, the design for a CMOS image sensor is very easy.

Furthermore, a constant current source and a column signal processing unit are connected to an opposite side of vertical signal lines, and a column signal processing unit connected to odd-numbered vertical signal lines is disposed on an opposite side of a column signal processing unit connected to even-numbered vertical signal lines. Thus, a space for laying-out column signal processing units can be ensured sufficiently.

Namely, a latest narrower-pitch configuration of a CMOS image sensor makes it extremely difficult to lay-out a column signal processing unit portion corresponding to one column within the pitch of a unit pixel. However, the constant current source and the column signal processing unit are connected to an opposite side of vertical signal lines, and the column signal processing unit connected to an odd-numbered vertical signal line is arranged on an opposite side of the column signal processing unit connected to an even-numbered vertical signal line. Accordingly, the column signal processing unit portion corresponding to the single column can be laid-out at a pitch double the pitch of the unit pixel. Consequently, the space for laying out the column signal processing units can be ensured sufficiently.

It should be understood by those skilled in the art that various modifications, combinations, sub-combinations and alternations may occur depending on design requirements and other factors insofar as they are within the scope of the appended claims or equivalents thereof.

What is claimed is:

1. A solid-state imaging device comprising:
a pixel array including a plurality of pixels arranged in a matrix, wherein each of the pixels includes a photoelectric conversion element;
vertical signal lines disposed for each pixel column in the pixel array and connected to a transistor at an output stage of the pixels in a source-follower configuration;
a constant current source for supplying a constant current to the vertical signal lines; and
a signal processing circuit configured to read out an electrical signal from the pixels,
wherein one side of the vertical signal lines are connected to the constant current source, and the other side of the vertical signal lines are connected to the signal processing circuit.

2. The solid-state imaging device according to claim 1, wherein the signal processing circuit connected to odd-numbered vertical signal lines is disposed on an opposite side of the signal processing circuit connected to even-numbered vertical signal lines.

3. A driving method for a solid-state imaging device which includes a pixel array including a plurality of pixels each of which includes a photoelectric conversion element, arranged in a matrix form, vertical signal lines disposed for each pixel column in the pixel array and connected to a transistor at an output stage of the pixels in a source-follower configuration, a constant current source, connected to the vertical signal lines, for supplying a constant current to the vertical signal lines, and a signal processing circuit, connected to the vertical signal lines, for reading out an electrical signal from the pixels, the method comprising the step of:
flowing a current in a direction opposite to the signal processing circuit by the constant current source to read out the electrical signal stored in the pixels to the signal processing circuit.

4. The driving method for a solid-state imaging device according to claims 3, wherein a direction of the current flowing through odd-numbered vertical signal lines is opposite to a direction of the current flowing through even-numbered vertical signal lines.
